(19) United States
(12) Patent Application Publication
(10) Pub. No.: US 2024/0270211 A1
(43) Pub. Date: Aug. 15, 2024

(54) COMBINED CLEANING APPARATUS FOR A SENSOR APPARATUS OF A VEHICLE

(71) Applicant: Continental Automotive Technologies GmbH, Hannover (DE)

(72) Inventor: Petr Novak, Prague (CZ)

(73) Assignee: Continental Automotive Technologies GmbH, Hannover (DE)

(21) Appl. No.: 18/691,338

(22) PCT Filed: Sep. 6, 2022
(86) PCT No.: PCT/DE2022/200207

§ 371 Date: Mar. 12, 2024

(30) Foreign Application Priority Data
Sep. 13, 2021 (DE) 10 2021 210 085.6

(51) Int. Cl. B60S 1/56; B60S 1/52; B60S 1/54

(52) U.S. Cl. CPC B60S 1/56; B60S 1/52; B60S 1/54

(57) ABSTRACT

A cleaning apparatus for cleaning an exposed surface of a sensor apparatus of a vehicle, including a hydraulic device for application of cleaning fluid to the exposed surface and a pneumatic device for targeted application of an air flow to the exposed surface. In order for the cleaning apparatus to be able to clean and dry in particular larger surfaces efficiently and evenly, the hydraulic device and the pneumatic device are combined in a common housing such that, when installed, the cleaning apparatus extends along at least one edge of the exposed surface.

### CROSS-REFERENCE TO RELATED APPLICATIONS

The present application is a National Stage Application under 35 U.S.C. § 371 of International Application No. PCT/DE2022/200207 filed on Sep. 6, 2022, and claims priority from German Patent Application No. 102021210085.6 filed on Sep. 13, 2021, in the German Patent and Trade Mark Office, the disclosures of which are herein incorporated by reference in their entireties.

### BACKGROUND

### 1. Field

Aspects and objects consistent with embodiments of the present application relate to a combined cleaning apparatus for cleaning and drying optical surfaces of various sensor apparatus in the external region of a vehicle, in particular cover panels for LIDAR sensors (Light Detection And Ranging).

### 2. Description of Related Art

Surfaces of cover panels, lenses and similar of optical sensors of a vehicle must always be kept clean for optimal functionality. If such surfaces are arranged on the surface in the exterior region of the vehicle, they are greatly exposed to environmental influences, regularly become soiled and must be cleaned using a special cleaning apparatus.

To this end, it is known to use cleaning devices with nozzles of the type used in headlight or windscreen cleaning systems, which spray a pressurized cleaning fluid onto the surface to be cleaned.

Here it is important to remove the cleaning fluid from the surface as quickly and completely as possible, since residual fluid droplets can also negatively affect the function of optical sensors, for example by deflecting and scattering the light.

Uncontrolled drying of the surface by natural environmental effects, such as travel wind, sunshine, etc., is slow and unreliable. In addition, after drying, the cleaning fluid may leave stains which should be avoided for both functional and also esthetic reasons.

To avoid this, it is known to combine fluid-based cleaning apparatus with special drying devices, which remove fluid residue from the surface more quickly and in controlled fashion by means of a defined air flow. With regard to the relevant prior art, reference is made by way of example to EP 2 949 520 A1.

Such combined cleaning devices are however extremely complex and susceptible to fault, require a comparatively large installation space in the direct vicinity of the sensor, and lead to high production and assembly costs owing to a large number of individual components and mounting operations.

LIDAR sensors in particular impose particularly high requirements for assigned cleaning apparatus. Firstly, for functional reasons, LIDAR sensors require adjacent transmitting and receiving units and hence necessarily have comparatively large, extensive cover panels. Secondly, a LIDAR is normally used for monitoring the space in front of the vehicle and must therefore be positioned on the vehicle front, which is particularly susceptible to soiling.

The above-mentioned cleaning devices have individual spot nozzles or sources for jets of cleaning fluid and compressed air, and can therefore only reliably clean and dry comparatively small surface areas. For satisfactory treatment of large surfaces such as LIDAR cover panels however, they are not optimally suited.

### SUMMARY

Aspects and objects of embodiments of the present application relate to a cleaning apparatus which can efficiently and evenly clean and dry in particular larger surfaces while avoiding the above-mentioned disadvantages.

### BRIEF DESCRIPTION OF THE DRAWINGS

Aspects and objects of the embodiments of the present application will now be described with respect to the drawings, in which:

FIG. 1 is a diagram of a cleaning apparatus according to an embodiment; and

FIG. 2 is a diagram of a cleaning apparatus according to an embodiment.

### DETAILED DESCRIPTION OF THE EMBODIMENTS

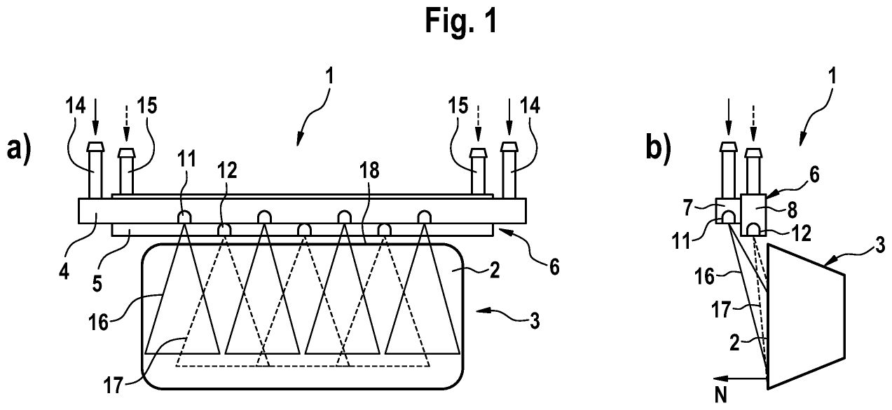

FIG. 1 shows, as an example and greatly simplified, a LIDAR sensor apparatus 3 with an assigned cleaning apparatus 1 according to the disclosure. View (a) of FIG. 1 illustrates a top view of the cleaning apparatus 1, and view (b) of FIG. 1 illustrates a side view of the cleaning apparatus 1.

The surface 2 to be cleaned of the illustrated sensor apparatus 3 or LIDAR has the form of a rounded rectangle. In practice, such cover panels may often also be trapezoidal. In any case, the surface 2 thereof is substantially larger, often by a factor of 10-30, than for example a lens of an average camera.

The housing 6 of the cleaning apparatus 1 is elongate and positioned along the longer edge 18 of the surface 2.

The housing 6 contains a hydraulic device 4 provided for cleaning the surface 2 with a cleaning fluid, and a pneumatic device 5 which serves for drying the surface 2 with a controlled air flow after a cleaning process, after driving through water or also for example in rain.

The hydraulic device 4 has a row of hydraulic nozzles 11 which are arranged spaced apart from one another along the housing 6 or the surface edge 18. On actuation of the hydraulic device 4, fluid jets 16 are sprayed simultaneously out of the nozzles 11 onto the surface 2. Because of the high number of nozzles 11, a majority of or ideally the entire surface 2 is wetted with cleaning fluid. To supply the hydraulic device 4 with cleaning fluid, hydraulic connections 14 are used which are connected to hydraulic lines (not shown here) leading from a hydraulic delivery device.

The pneumatic device 5 is constructed on the same principle as the hydraulic device 4 described above. The row of pneumatic nozzles 12 serves for simultaneous expulsion of compressed air in the form of several compressed air jets 17 in the direction of the surface 2. The required compressed air is supplied to the pneumatic device 5 via the pneumatic connections 15 from a pneumatic source (also not shown). Depending on application, a compressor, a compressed air store or other compressed air sources may be used as a pneumatic source.

Because of a spatial and functional separation of the hydraulic connections 14 and pneumatic connections 15, the hydraulic device 4 and pneumatic device 5 can be actuated individually as required, independently of one another.

The pneumatic device 5 may be briefly activated after every cleaning process with the hydraulic device 4, in order to be able to remove the residual cleaning fluid from the surface 2 as quickly and evenly as possible. The pneumatic device 5 may however also be permanently operated, in order for example, during wet weather conditions, to form a protective air film over the surface 2 which deflects the flying water droplets and prevents them from hitting the surface 2.

The number and the spacing of the nozzles 11 or 12 depends on the size of the surface 2, on the condition that the surface 2 is covered with fluid jets 16 and compressed air jets 17 as completely and evenly as possible.

The density of cleaning fluid differs greatly from the density of air. For optimal efficacy of the fluid jets 16 and the compressed air jets 17, the nozzles should be spaced and oriented differently relative to the surface 2. Therefore the housing 6 is shaped such that the rows of hydraulic nozzles 11 and pneumatic nozzles 12 are arranged orthogonally to one another relative to the surface 2 or its normal vector N and transversely offset.

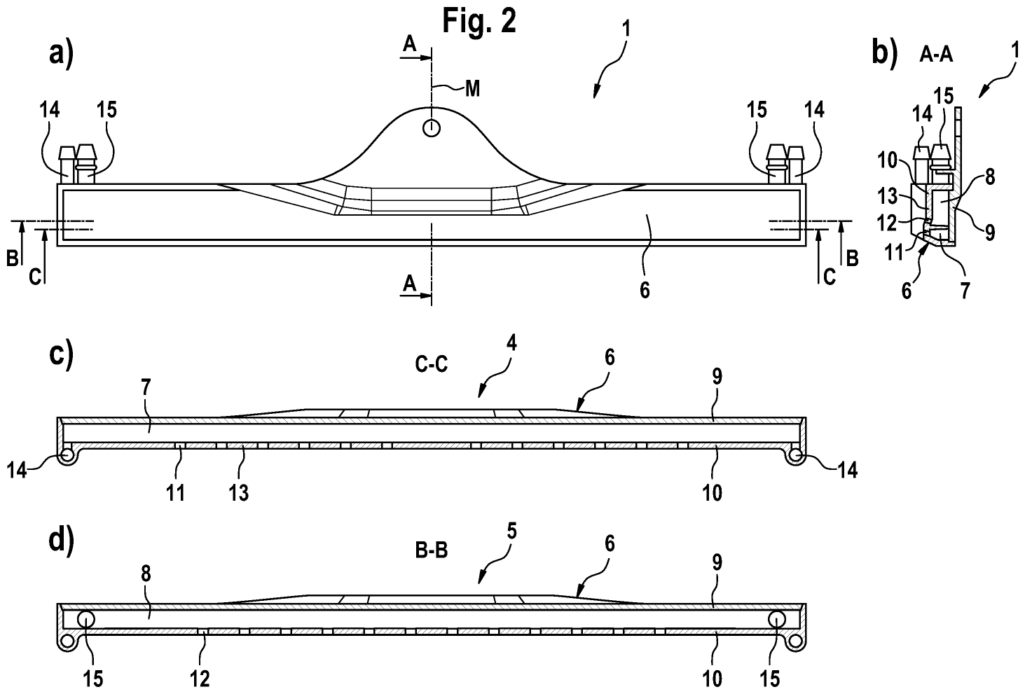

FIG. 2 illustrates the structure of an embodiment of the cleaning apparatus 1. View (a) of FIG. 2 illustrates a total component view of the cleaning apparatus, view (b) of FIG. 2 illustrates a cross-sectional view of the cleaning apparatus along a central plane, view (c) of FIG. 2 illustrates the hydraulic channel of the cleaning apparatus, and view (d) of FIG. 2 illustrates the pneumatic channel of the cleaning apparatus.

The elongate housing 6 is made of plastic and may be designed with a defined aerodynamic form, in order for example to favourably influence a flow induced by travel wind in the region of the adjacent surface to be cleaned and also to have an esthetically advantageous effect.

View (b) in FIG. 2 shows a cross-section through the central plane of the housing. The housing 6 is made from two housing parts 9, 10 which are preferably welded together or alternatively otherwise tightly connected together. On connection of the two housing parts 9 and 10, two structurally separate channels are formed in the housing—a hydraulic channel 7 assigned to the hydraulic device 4, and a pneumatic channel 8 assigned to the pneumatic device 5. The pneumatic channel 8 has a larger cross-section than the hydraulic channel 7. This promotes an even distribution of compressed air in the pneumatic channel 8 and on the surface 2, and also the consumption of the denser, incompressible cleaning fluid can be kept low without loss of function.

The hydraulic and pneumatic nozzles 11, 12 are arranged in a row one behind the other in the respective channel 7, 8. In the preferred embodiment illustrated, the nozzles 11, 12 are configured as simple openings in the housing wall 13. Evidently, other types of nozzles may also be used within the scope of the disclosure.

View (c) in FIG. 2 shows a longitudinal section through the hydraulic channel 7, and FIG. 2d shows a longitudinal section through the pneumatic channel 8.

Both the hydraulic channel 7 and also the pneumatic channel 8 are provided, at each of their opposite ends, with a corresponding connection 14, 15 for simultaneous filling of the respective channel with the associated working medium from both ends. For elongate channels with a great distance between the respective first and last nozzle, this has the advantage of faster and even filling of the respective channel. The spray pattern is thereby more even, the time offset between individual nozzles is reduced, and the formation of air bubbles in the hydraulic channel 7 is prevented.

For shorter designs of the cleaning apparatus 1, the channels 7, 8 may also be operated with only one respective connection 14, 15 within the scope of the disclosure.

1. A cleaning apparatus for cleaning an exposed surface of a sensor apparatus of a vehicle, the cleaning apparatus comprising:
a hydraulic device configured to apply a cleaning fluid to the exposed surface; and
a pneumatic device configured to apply an air flow to the exposed surface,
wherein the hydraulic device and the pneumatic device are combined in a common housing extending along at least one edge of the exposed surface.

2. The cleaning apparatus as claimed in claim 1, wherein the hydraulic device comprises at least one hydraulic channel, and
wherein the pneumatic device comprises at least one pneumatic channel structurally separate from the at least one hydraulic channel.

3. The cleaning apparatus as claimed in claim 2, wherein the at least one pneumatic channel has a cross-section larger than a cross-section of the at least one hydraulic channel.

4. The cleaning apparatus as claimed in claim 3, wherein the housing comprises a first housing part and a second housing part, and
wherein the at least one hydraulic channel and the at least one pneumatic channel are formed by connecting together the first housing part and the second housing part.

5. The cleaning apparatus as claimed in claim 4, further comprising a first row of nozzles configured for simultaneous spraying of cleaning fluid arranged along the at least one hydraulic channel.

6. The cleaning apparatus as claimed in claim 5, further comprising a second row of nozzles configured for simultaneous expulsion of compressed air arranged along the at least one pneumatic channel.

7. The cleaning apparatus as claimed in claim 6, characterized in that the first row of nozzles and the second row of nozzles are configured as openings in a housing wall of the housing.

8. The cleaning apparatus as claimed in claim 2, wherein the at least one hydraulic channel comprises a hydraulic connection for simultaneous supply with cleaning fluid at each end among opposite ends thereof.

9. The cleaning apparatus as claimed in claim 2, wherein the at least one pneumatic channel comprises a pneumatic connection for simultaneous supply with compressed air at each end among opposite ends thereof.

10. The cleaning apparatus as claimed in claim 6, wherein the first row of nozzles and the second row of nozzles are arranged orthogonally relative to the exposed surface and transversely offset to one another.
